(19) United States
(12) Patent Application Publication
(10) Pub. No.: US 2026/0163508 A1
(43) Pub. Date: Jun. 11, 2026

(54) MOTOR DRIVE CONTROL APPARATUS, DETERMINATION METHOD, AND STORAGE MEDIUM

(71) Applicant: CANON KABUSHIKI KAISHA, Tokyo (JP)

(72) Inventor: KEI HIGUCHI, Kanagawa (JP)

(21) Appl. No.: 19/395,288

(22) Filed: Nov. 20, 2025

(30) Foreign Application Priority Data
Dec. 6, 2024 (JP) 2024-213948

(51) Int. Cl. H02P 23/14; B65G 13/07; H02K 7/10; H02P 23/00

(52) U.S. Cl. CPC H02P 23/14; B65G 13/07; H02P 23/0022; B65G 2811/09; H02K 7/1004

(57) ABSTRACT

To make it possible to determine the cause of load variation in a motor drive control system, a motor drive control apparatus has a motor; a mechanical load driven by the motor; a control unit configured to control the motor; a detection unit configured to detect drive data including input data and output data in a system including the motor and the mechanical load; a status monitoring model calculation unit configured to calculate a status monitoring model using the drive data, the status monitoring model being formed by a plurality of parameters; and a determination unit configured to determine a cause of variation in a characteristic of the system including the motor and the mechanical load based on a change in the parameters forming the status monitoring model.

### BACKGROUND

### Field of the Technology

The present disclosure relates to a motor drive control apparatus, a determination method, and a storage medium.

### Description of the Related Art

As a method for monitoring load variation in a motor drive control apparatus, there has conventionally been a method for monitoring rotational speed in the motor drive control apparatus. For example, for the speed monitoring, there is a method that compares the amount of time between a motor drive control apparatus staring driving and the motor drive control apparatus reaching a reference rotation speed with a preset reference startup time, as Japanese Patent Laid-Open No. 2014-2202 does.

While Japanese Patent Laid-Open No. 2014-2202 can monitor load variation in a motor drive control apparatus, there is a problem in that the cause of the load variation cannot be determined. Although monitoring the time for a drive signal to rise in a motor drive control system makes it possible to monitor load variation in the motor drive control system, but cannot determine the cause of the load variation in the motor drive control system.

### SUMMARY

The present disclosure has been made in view of the above problem and aims to enable determination of the cause of load variation in a motor drive control system.

In an aspect of the present disclosure, there is provided a motor drive control apparatus comprising: a motor; a mechanical load driven by the motor; a control unit configured to control the motor; a detection unit configured to detect drive data including input data and output data in a system including the motor and the mechanical load; a status monitoring model calculation unit configured to calculate a status monitoring model using the drive data, the status monitoring model being formed by a plurality of parameters; and a determination unit configured to determine a cause of variation in a characteristic of the system including the motor and the mechanical load based on a change in the parameters forming the status monitoring model.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing an example functional configuration of a motor drive control apparatus according to a first embodiment of the present disclosure;

FIG. 2 is a flowchart showing the order in which the functional blocks forming the motor drive control apparatus function in the first embodiment of the present disclosure;

FIG. 3 is a diagram illustrating the concept of status monitoring in the first embodiment of the present disclosure;

FIG. 4 is a diagram illustrating a change in a parameter Pa caused by a change in temperature and a change in the parameter Pa caused by a change in load torque change, the parameter Pa forming a status monitoring model in the first embodiment of the present disclosure;

FIG. 5 is a diagram illustrating a change in a parameter Pb caused by a change in temperature and a change in the parameter Pb caused by a change in load torque, the parameter Pb forming the status monitoring model in the first embodiment of the present disclosure;

FIG. 6 is a diagram illustrating a rate of change of gain from an initial value and a rate of change of dead time from an initial value in relation to a change in temperature in a case where the status monitor model is formed by a first-order plus dead time model in the first embodiment of the present disclosure;

FIG. 7 is a diagram illustrating a rate of change of gain from an initial value and a rate of change of dead time from an initial value in relation to a change in load torque in a case where the status monitor model is formed by a first-order plus dead time model in the first embodiment of the present disclosure;

FIG. 8 is a diagram illustrating a functional configuration of a conveyance system of a printer as an example of a motor drive control apparatus in a second embodiment of the present disclosure; and

FIG. 9 is a conceptual diagram illustrating a method for calculating the status monitoring model in the embodiments of the present disclosure.

### DESCRIPTION OF THE EMBODIMENTS

Embodiments are described in detail below with reference to the drawings attached hereto. Note that the embodiments below do not limit the disclosure according to the scope of claims. Although a plurality of features are described in the embodiments, not all these features are necessarily essential for the disclosure, and the features may be combined as needed. Further, regarding the accompanying drawings, the same or like configurations are denoted by the same reference numeral to avoid repetitive descriptions.

### First Embodiment

An embodiment of the present disclosure is described in specific terms below with reference to the drawings. Note that throughout the drawings, the same reference numeral denotes the same or corresponding portions.

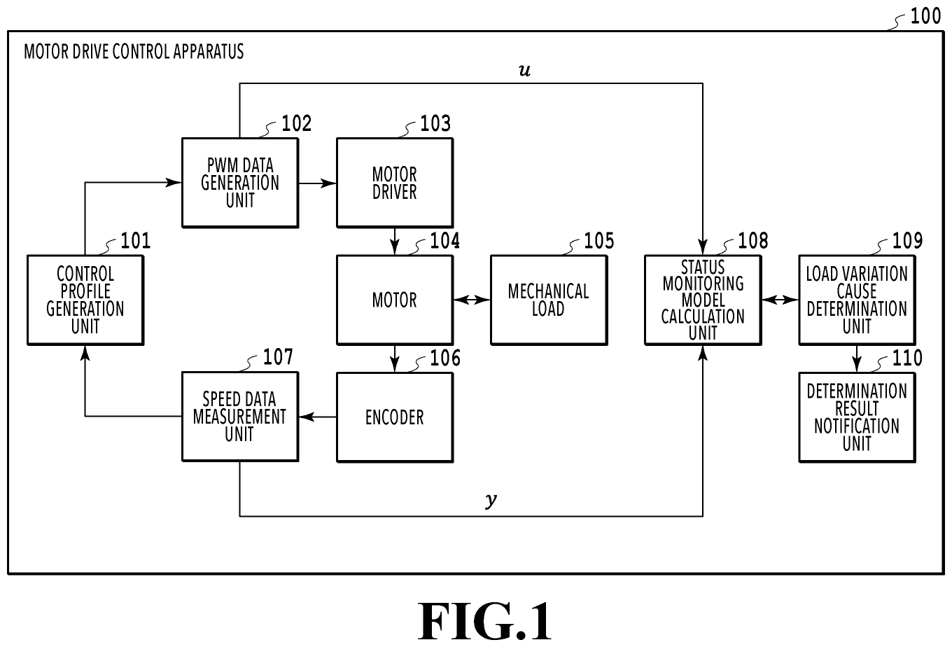

FIG. 1 is a block diagram showing an example functional configuration of a motor drive control apparatus 100 of a first embodiment. The motor drive control apparatus 100 includes a control profile generation unit 101, a PWM data generation unit 102, a motor driver 103, a motor 104, a mechanical load 105, and an encoder 106. The motor drive control apparatus 100 also includes a speed data measurement unit 107, a status monitoring model calculation unit 108, a load variation cause determination unit (or simply a “determination unit”) 109, and a determination result notification unit 110.

The control profile generation unit 101 is a functional block that generates a speed command profile for driving the motor drive control apparatus 100.

The PWM data generation unit 102 is a functional block that converts the speed command profile generated by the control profile generation unit 101 into PWM data. PWM data is data specifying speed based on a duty cycle.

The motor driver 103 drives and rotates the motor 104 based on the PWM data generated by the PWM data generation unit 102.

The motor 104 is driven and rotated by the motor driver 103. An example of the motor 104 is a DC motor, but the present disclosure is not limited to a DC motor.

The mechanical load 105 is a mechanical component or the like connected to the motor 104, and examples thereof include a gear, a pulley, a belt, and a roller.

The encoder 106 is a rotational speed detection unit that detects the rotational speed of the motor 104, and a rotary encoder or the like is used as an example thereof.

The speed data measurement unit 107 is a functional block that converts a detection value from the encoder 106 into speed data.

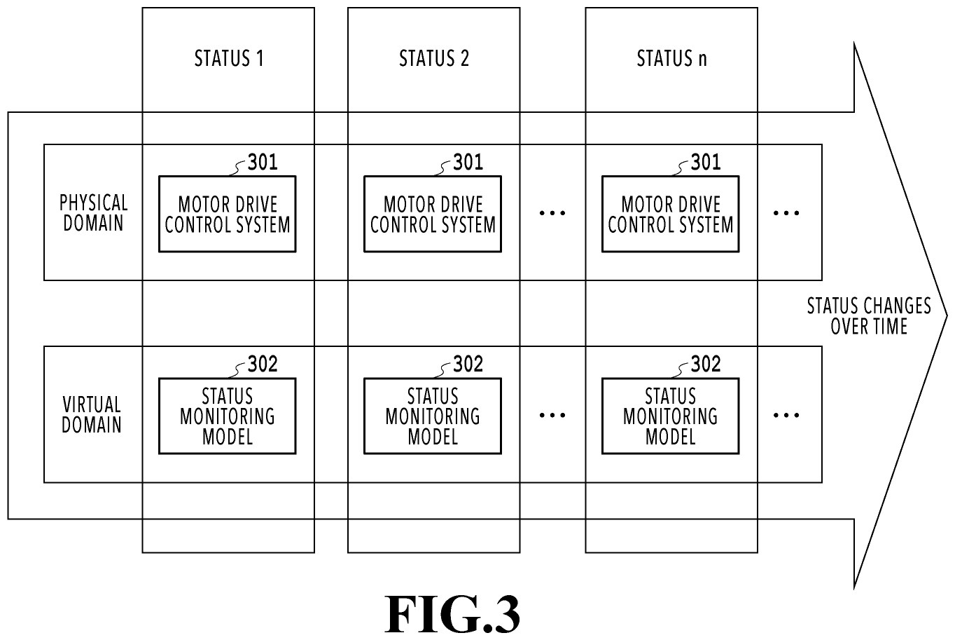

The status monitoring model calculation unit 108 receives input of voltage data from the PWM data generation unit 102. This voltage data represents speed as the PWM data does. The speed here is not a target speed but a speed directly instructed to the motor. The status monitoring model calculation unit 108 also receives input of voltage data from the speed data measurement unit 107. This voltage data represents the speed detected by the encoder 106. The status monitoring model calculation unit 108 is a functional block that calculates a status monitor model 302 (see FIG. 3) for monitoring the status of the motor drive control apparatus 100. Here, the status monitor model 302 represents the dynamic characteristics of the motor drive control apparatus 100. Note that the control profile generation unit 101 performs feedback control taking the PWM data generated by the PWM data generation unit 102 as an input and the speed data converted by the speed data measurement unit 107 as an output. Thus, the control profile generation unit 101 also functions as a control unit. The status monitoring model calculation unit 108 can also be implemented by a processor reading a program stored in a storage unit (not shown) such as read-only memory (ROM) and executing the program.

The load variation cause determination unit 109 is a functional block that monitors changes in parameters forming the status monitor model 302 calculated by the status monitoring model calculation unit 108 and determines the cause of load variation in the motor drive control apparatus 100.

Although the load variation cause determination unit 109 is in the motor drive control apparatus 100 in FIG. 1, the load variation cause determination unit 109 may be a functional block provided outside the motor drive control apparatus 100. The load variation cause determination unit 109 may be provided outside the motor drive control apparatus 100 in a case where, for example, the motor drive control apparatus 100 is a printer and the load variation cause determination unit 109 is an external server.

The determination result notification unit 110 is a functional block that notifies a user of the motor drive control apparatus 100 of the result of the determination reached by the load variation cause determination unit 109. Examples of the determination result notification unit 110 include a display unit on a printer. Although the determination result notification unit 110 is in the motor drive control apparatus 100 in FIG. 1, the determination result notification unit 110 may be a functional block provided outside the motor drive control apparatus 100, similarly with the load variation cause determination unit 109. The determination result notification unit may be provided outside the motor drive control apparatus 100 in a case where, for example, the motor drive control apparatus 100 is a printer and the determination result notification unit is an externally-connected personal computer (PC) or smartphone.

The status monitor model 302 calculated by the status monitoring model calculation unit 108 in FIG. 1 has a plurality of parameters. Examples of the status monitor model 302 include a first-order plus dead time model having three parameters: time constant, gain, and dead time. Dead time here represents the period of delay for an output value to begin to respond after input of a command value. While dead time is sometimes defined as the time it takes to reach 90% of the command value from the start point of the control profile, the definition of dead time in a first-order plus dead time model is not limited to the above definition. The status monitor model 302 formed using a first-order plus dead time model is expressed as the following formula of a transfer function representation:

$$P = \frac{{Ke}^{- Ls}}{( Ts + 1 )} ,$$

where P is the status monitor model 302, K is gain, L is dead time, and T is time constant, which are parameters of the status monitor model 302. Note that e is a Napier's constant, and s is a complex number. They are used similarly to the way they are used in a typical mathematical expression with a transfer function.

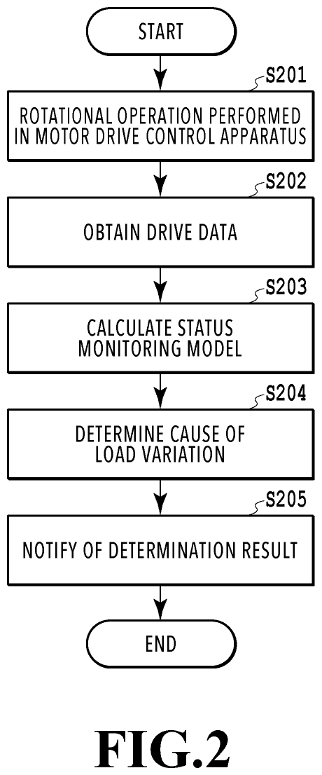

FIG. 2 is a flowchart showing the order in which the functional blocks constituting the motor drive control apparatus 100 shown in FIG. 1 function in the first embodiment.

First, the motor drive control apparatus 100 drives and rotates the motor 104 and the mechanical load 105 based on a speed command profile generated by the control profile generation unit 101 (S201).

Next, the status monitoring model calculation unit 108 obtains speed data (input speed data) representing the speed represented by the PWM data used in the rotation driving in S201 and generated by the PWM data generation unit 102. The status monitoring model calculation unit 108 also obtains speed data (output speed data) used in the rotation driving in S201 and converted by the speed data measurement unit 107 (S202). Depending on the control method, data other than speed data may be obtained here. For example, positional data may be obtained, or speed data and positional data may be obtained. These are collectively referred to as drive data herein. Drive data includes input data and output data. The input speed data corresponds to the input data, and the output speed data corresponds to the output data.

Next, using the input speed data and the output speed data obtained in S202, the status monitoring model calculation unit 108 calculates the status monitor model 302 based on a particular calculation algorithm (S203).

Next, the load variation cause determination unit 109 monitors changes in the parameters of the status monitor model 302 calculated in S203 and thereby determines the cause of load variation in the motor drive control apparatus 100 (S204).

Next, the determination result notification unit 110 notifies the user of the motor drive control apparatus 100 of the result of the determination reached by the load variation cause determination unit 109 (S205).

By repeating S201 to S205, the motor drive control apparatus 100 repeatedly calculates the status monitor model 302 and determines the cause of load variation in the motor drive control apparatus 100.

FIG. 3 is a diagram illustrating the concept of status monitoring in the first embodiment and shows how the status transitions from status 1 to status 2, status n, and so on sequentially as time passes. The status monitoring model calculation unit 108 in FIG. 1 and the status monitor model 302 calculated in S203 in the flowchart in FIG. 3 mathematically represent four functional blocks in the motor drive control apparatus 100: the motor driver 103, the motor 104, the mechanical load 105, and the encoder 106. In other words, a motor drive control system 301 in the physical domain and the status monitor model 302 in the virtual domain have corresponding relations. Thus, in a case where there is a change in the motor drive control system 301 in the physical domain, a change is observed in the status monitor model 302 in the virtual domain as well. Hence, it is possible to monitor a change in the motor drive control system 301 by monitoring the virtual status monitor model 302 calculated based on the input speed data and the output speed data obtained from the motor drive control system 301 in the physical domain.

A change in the motor drive control system 301 appears in the status monitor model 302, and the cause of the change in the motor drive control system 301 can be determined using a difference in change tendency between the parameters forming the status monitor model 302. The following shows an example where the status monitor model 302 is formed by a parameter Pa and a parameter Pb.

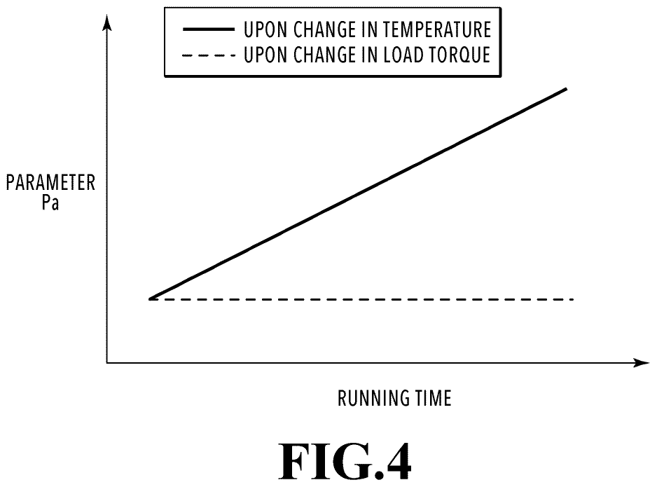

FIG. 4 shows a graph for the parameter Pa, where the horizonal axis represents running time and the vertical axis represents the value of the parameter. In FIG. 4, the solid line represents changes caused by a change in the temperature of the motor 104, and the broken line represents changes caused by a change in the load torque of the mechanical load 105. The parameter Pa is a parameter that changes with a change in the temperature of the motor 104 in the motor drive control apparatus 100 and does not change with factors other than a change in the temperature of the motor 104.

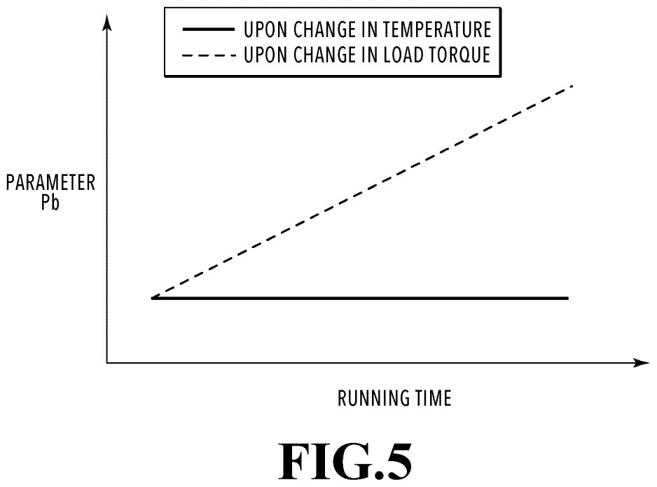

By contrast, FIG. 5 shows a graph for the parameter Pb, where the horizonal axis represents running time and the vertical axis represents the value of the parameter. In FIG. 5, the solid line represents changes caused by a temperature change in the motor 104, and the broken line represents changes caused by a change in the load torque of the mechanical load 105. The parameter Pb is a parameter that changes with a change in the load torque of the mechanical load 105 in the motor drive control apparatus 100 and does not change due to factors other than a change in the load torque of the mechanical load 105.

The status monitor model 302 is repeatedly calculated according to the flowchart in FIG. 2 to monitor changes in the parameter Pa and the parameter Pb. In a case where the monitor result indicates that there is a change only in the parameter Pa and not in the parameter Pb, it is possible to determine based on the difference in change tendency between the parameter Pa and the parameter Pb that there has been a change in the motor drive control apparatus 100 due to a change in the temperature of the motor 104. Also, in a case where the monitor result indicates that there is a change only in the parameter Pb and not in the parameter Pa, it is possible to determine based on the difference in the change tendency between the parameter Pa and the parameter Pb that there has been a change in the motor drive control apparatus 100 due to a change in the load torque of the mechanical load 105. Note that the above two examples show a case of using the status monitor model 302 formed by two parameters to determine the cause of a change in the motor drive control apparatus 100 based on the difference in the change tendency between the parameters.

Now a description is given of an example of how the cause of load variation in the motor drive control apparatus 100 is determined in a case where the status monitor model 302 is a first-order plus dead time model having three parameters: time constant, gain, and dead time. In this example, the cause of load variation is determined to be either a change in the temperature of the motor 104 or a change in the load torque of the mechanical load 105.

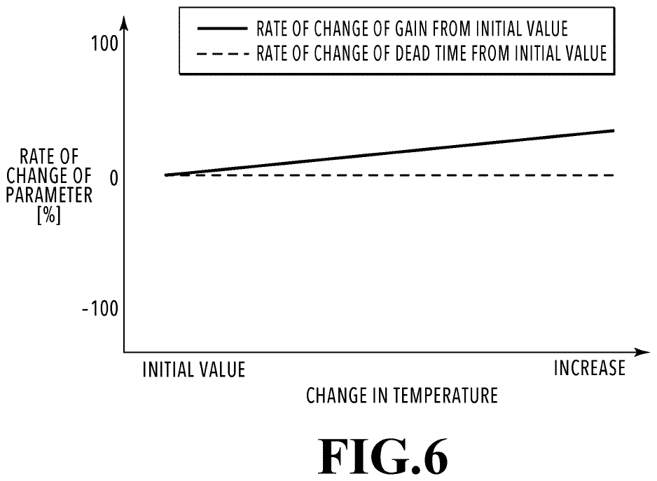

FIG. 6 shows a rate of change of the gain of the status monitor model 302 from an initial value and a rate of change of the dead time of the status monitor model 302 from an initial value, in relation to a change in the temperature of the motor 104. In FIG. 6, the horizontal axis represents temperature change, the vertical axis represents a rate of change of the parameters, the solid line represents a rate of change of the gate from the initial value, and the broken line represents a rate of change of the dead time from the initial value. As the temperature rises, the rate of change of the gain from the initial value increases, whereas the rate of change of the dead time from the initial value stays at 0%.

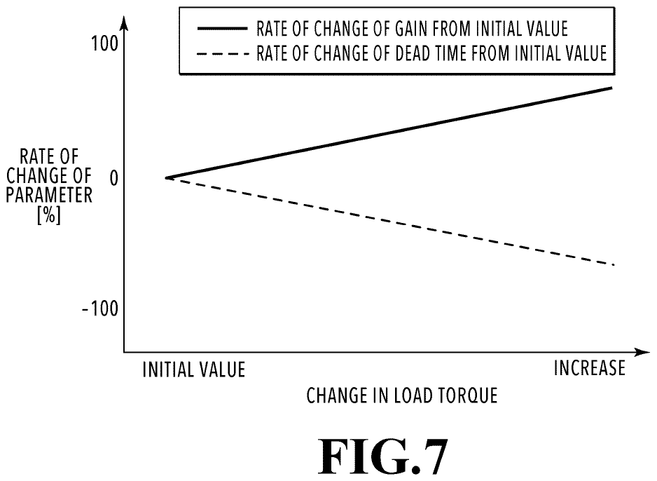

FIG. 7 shows a rate of change of the gain of the status monitor model 302 from the initial value and a rate of change of the dead time of the status monitor model 302 from the initial value, in relation to a change in the load torque of mechanical load 105. In FIG. 7, the horizontal axis represents change in load torque, and the vertical axis represents a rate of change of the parameters. What the lines represent are the same as those in FIG. 6. As the load torque increases, the rate of change of the gain from the initial value increases, whereas the rate of change of the dead time from the initial value decreases.

In a comparison between FIGS. 6 and 7, although the rate of change of the gain from the initial value increases in both cases of the rise of the temperature and the increase in the load torque, the change is larger with the increase in the load torque.

By contrast, the rate of change of the dead time from the initial value does not change and is constant in the case of the rise in temperature, but decreases in the case of the increase in the load torque.

Thus, in a case where the status monitor model 302 is formed of a first-order plus dead time model, it is possible to determine the cause of load variation in the motor drive control apparatus 100 by using the difference in change tendency between the gain and the dead time. For example, in a case where both the gain and the dead time increase, it can be determined that the temperature has increased. Also, in a case where the gain increases and the dead time decreases, it can be determined that the load torque has increased.

A first-order plus dead time model has been introduced above as an example of the status monitor model 302. However, it is possible to identify the cause of a change in the motor drive control apparatus 100 from three or more causes by increasing the number of parameters forming the status monitor model 302 to three or more parameters or combining differences in change tendency between parameters.

### Second Embodiment

A second embodiment of the present disclosure relates to a status monitoring model for a conveyance system of a printer as an example of a motor drive control apparatus.

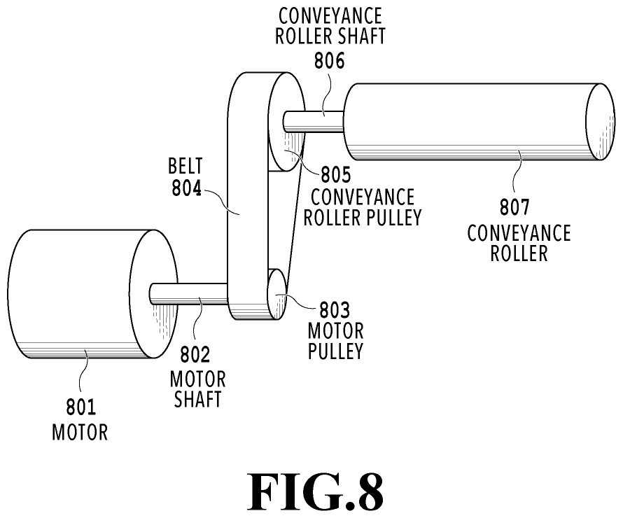

A description is given of an example where the motor drive control apparatus 100 is a conveyance system of a printer. FIG. 8 shows the functional configuration of the conveyance system of the printer, and the conveyance system is formed of a motor 801, a motor shaft 802, a motor pulley 803, a belt 804, a conveyance roller pulley 805, a conveyance roller shaft 806, and a conveyance roller 807. However, power transmission from the motor 801 to the conveyance roller 807 in the conveyance system of the printer is not limited to the belt 804, and a configuration where gears are used for power transmission may be employed. The status monitor model 302 of the conveyance system of the printer shown in FIG. 8 can be formed as expressed in Formula 1 below:

$$\begin{matrix}\{ \begin{matrix}\dot{x} = Ax + Bu \\ y = Cx + Du\end{matrix} \\ where \\ x = [ \begin{matrix}{θ}_{m} \\ {\dot{θ}}_{m} \\ {θ}_{r} \\ {\dot{θ}}_{r} \\ I\end{matrix} ] \\ u = V \\ y = {\dot{θ}}_{r} \\ A = [ \begin{matrix}0 & 1 & 0 & 0 & 0 \\ - {R}_{m}^{2} {K}_{b} / {J}_{m} & - ( {D}_{m} + {T}_{lm} + {R}_{m}^{2} {D}_{b} ) / {J}_{m} & {R}_{m} {R}_{r} {K}_{b} / {J}_{m} & {R}_{m} {R}_{r} {D}_{b} / {J}_{m} & {K}_{mtr} / {J}_{m} \\ 0 & 0 & 0 & 1 & 0 \\ {R}_{m} {R}_{r} {K}_{b} / {J}_{r} & {R}_{m} {R}_{r} {D}_{b} / {J}_{r} & - {R}_{r}^{2} {K}_{b} / {J}_{r} & - ( {D}_{m} + {T}_{lm} + {R}_{m}^{2} {D}_{b} ) / {J}_{m} & 0 \\ 0 & - {K}_{mtr} / {L}_{mtr} & 0 & 0 & - {R}_{mtr} / {L}_{mtr}\end{matrix} ] \\ B = [ \begin{matrix}0 \\ 0 \\ 0 \\ 0 \\ 1 / {L}_{mtr}\end{matrix} ] \\ C = [ 00010 ] \\ D = 0\end{matrix} \qquad ( Formula 1 )$$

The parameters in Formula 1 are defined as follows:
V: motor voltage
I: motor current
θₘ: motor position
\dot{θ}ₘ: motor speed
Rₘₜᵣ: motor's terminal resistance
Lₘₜᵣ: motor inductance
Kₘₜᵣ: motor torque coefficient
Rₘ: motor pulley radius
Dₘ: motor viscous resistance coefficient
Jₘ: motor inertial resistance coefficient
Tₗₘ: motor friction load coefficient
K_{b}: belt spring coefficient
D_{b}: belt viscous coefficient
θᵣ: conveyance roller position
\dot{θ}ᵣ: conveyance roller speed
Rᵣ: conveyance roller pulley radius
Dᵣ: conveyance roller viscous resistance coefficient
Jᵣ: conveyance roller inertial resistance coefficient
Tₗᵣ: conveyance roller friction load coefficient.

The parameters of the status monitor model 302 shown in Formula 1 correspond to the motor 801, the motor shaft 802, the motor pulley 803, the belt 804, the conveyance roller pulley 805, the conveyance roller shaft 806, and the conveyance roller 807 shown in FIG. 8. Thus, in the event of a status change inside the conveyance system, the numerical value of a corresponding parameter changes in the status monitor model 302. Thus, it is possible to identify the location of the status change in the conveyance system of the printer by checking the parameter that changed in the status monitor model 302. For example, in a case where a change in the motor torque coefficient Kₘₜᵣ is observed in the status monitor model 302, it can be identified that there has been a change in the motor 801 in the conveyance system. Note that the series of processes performed in the conveyance system of the printer shown in FIG. 8, including driving the conveyance system, determining the cause of load variation using the status monitoring model, and notifying of the determination result, are similar to FIG. 2 for the first embodiment and are therefore not described here.

### <Method of Calculating the Status Monitoring Model>

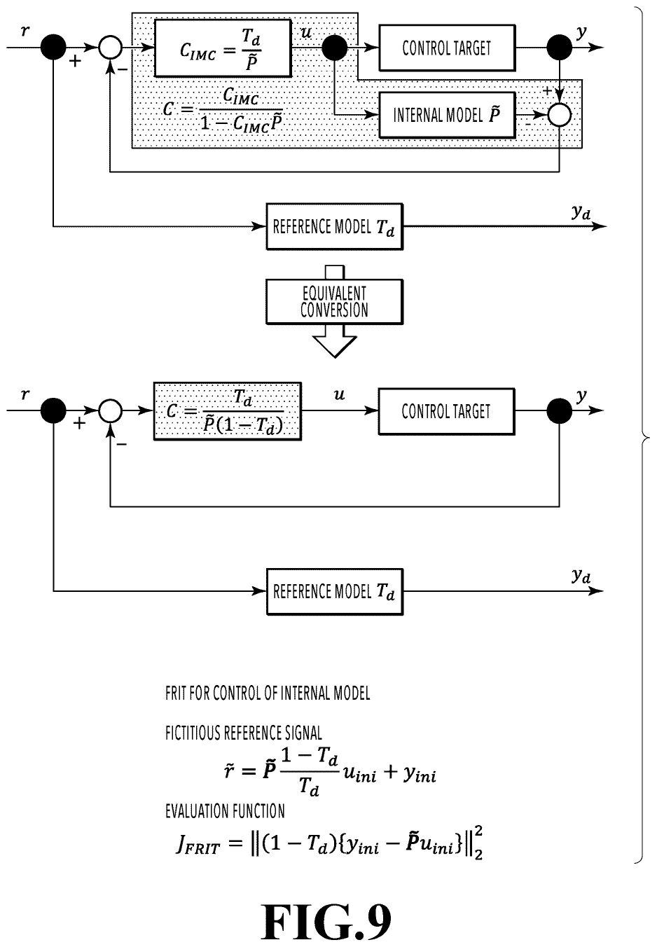

An input u and an output y on a control target shown in FIG. 9 correspond to the data u (see FIG. 1) inputted from the PWM data generation unit 102 to the status monitoring model calculation unit 108 and the data y (see FIG. 1) inputted from the speed data measurement unit 107 to the status monitoring model calculation unit 108, respectively. An internal model corresponds to the status monitoring model.

In fictious reference iterative tuning (FRIT) for internal model control in the field of study of data-driven control, a fictious reference signal ř is expressed as follows:

$${r}^{⋁} = {P}^{⋁} \frac{1 - {T}_{d}}{{T}_{d}} {u}_{ini} + {y}_{ini}$$

where Td is a response transfer function and \tilde{P} is the status monitoring model.

An evaluation function J_{FRIT} is as follows:

$${J}_{FRIT} = {‖ ( 1 - {T}_{d} ) \{ {y}_{ini} - \tilde{P} {u}_{ini} \} ‖}_{2}^{2} .$$

The status monitoring model \tilde{P} can be calculated by minimizing the evaluation function J_{FRIT} using the least squares method or the like.

In the first embodiment,
yᵢₙᵢ is the output speed data,
uᵢₙᵢ is the input speed data, and

$$P = {Ke}^{- Ls} / ( Ts + 1 ) .$$

In the second embodiment,
u=V (motor voltage),
y=\dot{θ}ᵣ (conveyance roller speed), and

$$P = {C ( sI - A )}^{- 1} B + D .$$

Td shown in FIG. 9 is what the status monitoring model calculation unit 108 has thereinside. Td is, for example, T_{d}=e^{-Ls}/(s+1) in the first embodiment and is, for example, T_{d}=1/(s+1) in the second embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (Such as a compact disc (CD), digital versatile disc (DVD), or Blu-ray Disc (BD)™), a flash memory device, a memory card, and the like.

The present disclosure can determine the cause of load variation in a motor drive control system.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-213948, filed Dec. 6, 2024, which is hereby incorporated by reference herein in its entirety.

What is claimed is:

1. A motor drive control apparatus comprising:
a motor;
a mechanical load driven by the motor;
a control unit configured to control the motor;
a detection unit configured to detect drive data including input data and output data in a system including the motor and the mechanical load;
a status monitoring model calculation unit configured to calculate a status monitoring model using the drive data, the status monitoring model being formed by a plurality of parameters; and
a determination unit configured to determine a cause of variation in a characteristic of the system including the motor and the mechanical load based on a change in the parameters forming the status monitoring model.

2. The motor drive control apparatus according to claim 1, wherein
the status monitoring model represents a dynamic characteristic of the system including the motor and the mechanical load.

3. The motor drive control apparatus according to claim 1, wherein
there is a difference in change tendency between the parameters forming the status monitoring model, and
the cause of variation is determined by use of the difference in change tendency between the parameters.

4. The motor drive control apparatus according to claim 1, wherein
in a case where one of the parameters that tends not to change upon a change in load torque and tends to change upon a change in temperature changes and another one of the parameters that tends to change upon the change in load torque and tends not to change upon the change in temperature does not change, the determination unit determines that the cause of variation is the change in temperature.

5. The motor drive control apparatus according to claim 1, wherein
in a case where one of the parameters that tends not to change upon a change in load torque and tends to change upon a change in temperature does not change and another one of the parameters that tends to change upon the change in load torque and tends not to change upon the change in temperature changes, the determination unit determines that the cause of variation is the change in load torque.

6. The motor drive control apparatus according to claim 1, wherein
the status monitoring model has three parameters: time constant, gain, and dead time.

7. The motor drive control apparatus according to claim 1, wherein
the status monitoring model has three parameters: time constant, gain, and dead time, and
using a difference in change tendency between the time constant and the dead time, it is determined whether the cause of variation is a rise in temperature of the motor or variation in the mechanical load.

8. The motor drive control apparatus according to claim 1, wherein
as the input data, the drive data includes data on voltage for driving the motor.

9. The motor drive control apparatus according to claim 8, wherein
the voltage corresponds to PWM data specifying speed of the motor.

10. The motor drive control apparatus according to claim 1, wherein
as the output data, the drive data includes speed of the motor detected by an encoder.

11. The motor drive control apparatus according to claim 1, wherein
the mechanical load includes a conveyance roller driven by the motor via a motor pulley, a belt, and a conveyance roller pulley, and
as the output data, the drive data includes speed of the conveyance roller.

12. A method for determining a cause of variation in a motor drive control apparatus having a motor, a mechanical load driven by the motor, and a control unit configured to control the motor, the method comprising:
detecting drive data including input data and output data in a system including the motor and the mechanical load;
calculating a status monitoring model using the drive data, the status monitoring model being formed by a plurality of parameters; and
determining a cause of variation in a characteristic of the system including the motor and the mechanical load based on a change in the parameters forming the status monitoring model.

13. A non-transitory computer-readable storage medium storing a program for causing a computer to execute a method for determining a cause of variation in a motor drive control apparatus having a motor, a mechanical load driven by the motor, and a control unit configured to control the motor, the method comprising:
detecting drive data including input data and output data in a system including the motor and the mechanical load;
calculating a status monitoring model using the drive data, the status monitoring model being formed by a plurality of parameters; and
determining a cause of variation in a characteristic of the system including the motor and the mechanical load based on a change in the parameters forming the status monitoring model.
